(19) United States
(12) Patent Application Publication
(10) Pub. No.: US 2010/0186570 A1
(43) Pub. Date: Jul. 29, 2010

(54) METHOD FOR MAKING AN OPTICAL FILM HAVING A VARIABLE PRISMATIC STRUCTURED SURFACE

(75) Inventors: Dale L. Ehnes, Cotati, CA (US); Mark E. Gardiner, Santa Rosa, CA (US); Alan B. Campbell, Santa Rosa, CA (US); Daniel S. Wertz, Sebastopol, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/362,048

(22) Filed: Jan. 29, 2009

(51) Int. Cl. B26D 3/08; G06F 19/00

(52) U.S. Cl. 83/881; 83/861; 83/880; 700/193

(57) ABSTRACT

A method for machining a workpiece can be used to make prismatic structures in the workpiece. The method involves machining the surface of the workpiece using an FTS actuator to make continuous features in the surface and machining the surface of the workpiece using flycutting to make discontinuous features in the surface through the continuous features. The discontinuous features are machined at a non-parallel angle to the continuous features. The machined workpiece can then be used to make films having particular optical or mechanical properties.

### BACKGROUND

Liquid crystal display (LCD) devices can use a backlight with a diffuser, reflective polarizing film, and brightness enhance film (BEF). These separate components must be handled in assembly of the display, which can be complicated based upon the number of components. Also, for some systems this total stack of films is too thick.

### SUMMARY

A method for machining a workpiece, consistent with the present invention, can be used to make generally prismatic structures in the workpiece. The method involves machining a surface of the workpiece using a fast tool servo (FTS) actuator to make continuous features in the surface the machining the surface of the workpiece using flycutting to make discontinuous features in the surface through the continuous features. The discontinuous features are machined at a non-parallel angle to the continuous features. The machined workpiece can then be used to make films having particular optical or mechanical properties.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of an FTS cutting tool system for making microstructures in a work piece;

FIG. 2 is an illustration of a flycutting system;

FIG. 3 is an illustration of flycutting system with the flycutting head inclined at an angle relative to the axis of rotation of a workpiece;

FIGS. 4a and 4b illustrate top and perspective views of an article having pyramids with no structural variation;

FIGS. 5a and 5b illustrate top and perspective views of an article having X axis chaos (vertical grooves) cut into regular prismatic microstructure (horizontal grooves);

FIGS. 6a and 6b illustrate top and perspective views of an article having X axis chaos intersecting X axis chaos at 90 degrees on a film;

FIGS. 7a and 7b illustrate top and perspective views of an article having Z axis chaos (vertical grooves) cut into regular prismatic microstructure (horizontal grooves);

FIGS. 8a and 8b illustrate top and perspective views of an article having Z axis chaos intersecting Z axis chaos at 90 degrees;

FIGS. 9a and 9b illustrate top and perspective views of an article having Z axis chaos intersecting Z axis chaos at 45 degrees on a film;

FIGS. 10a and 10b illustrate top and perspective views of an article having Z axis chaos intersecting Z axis chaos with a depth mismatch;

FIGS. 11a and 11b illustrate top and perspective views of an article having Z axis chaos (horizontal grooves) cut into regular prismatic microstructure (vertical grooves) where both passes have a radius;

FIGS. 12a and 12b illustrate top and perspective views of an article made from three cutting passes with the Z axis orthogonal to the linear prismatic and Z axis at 45 degrees;

FIGS. 13a and 13b illustrate top and perspective views of an article made from synchronous sine waveform X axis FTS in two orthogonal directions;

FIGS. 14a and 14b illustrate top and perspective views of an article made from synchronous pseudo random Z axis FTS in two orthogonal directions; and

FIGS. 15a and 15b illustrate top and perspective views of an article made from synchronous sine waveform of rotational on axis “yaw” FTS in two orthogonal directions.

### DETAILED DESCRIPTION

Embodiments of the present invention include methods of making microstructured features that are the result of intersecting structures and may be considered generally pyramidal in nature. With films having such microsctructured features, it is possible to achieve a circularly symmetric luminance distribution in a luminance enhancement film. Furthermore, it is possible with these microstructures to tune the luminance distribution from circular to football shaped. Using a non-straight line cut allows for the film to have anti-moiré characteristics. Other embodiments allow the construction of negative pyramids, which are essentially an indented microstructure and can provide scratch resistance. These intersecting structures allow the formation of films providing optical gain and also functioning as a diffuser.

### FTS Cutting Tool System

General diamond turning techniques are described in PCT Published Application WO 00/48037, incorporated herein by reference as if fully set forth. The apparatus used in methods for making optical films or other films can include an FTS. As disclosed in WO 00/48037, an FTS is a solid state piezoelectric (PZT) device, referred to as a PZT stack, which rapidly adjusts the position of a cutting tool attached to the PZT stack. The FTS allows for highly precise and high speed movement of the cutting tool in directions within a coordinate system.

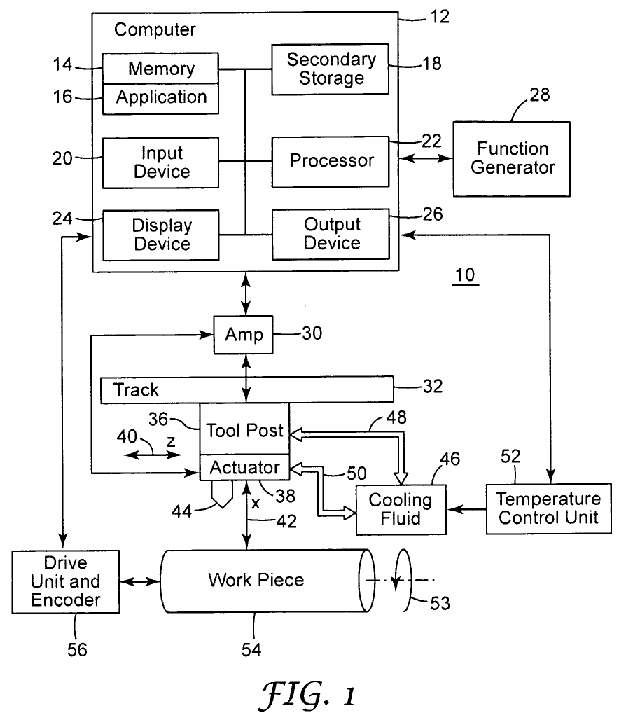

FIG. 1 is a diagram of a cutting tool system 10 for making microstructures in a work piece. Microstructures can include any type, shape, and dimension of structures on, indenting into, or protruding from the surface of an article. For example, microstructures created using the actuators and system described in the present specification can have a 1000 micron pitch, 100 micron pitch, 1 micron pitch, or even a sub-optical wavelength pitch around 200 nanometers (nm). These dimensions are provided for illustrative purposes only, and microstructures made using the actuators and system described in the present specification can have any dimension within the range capable of being tooled using the system.

System 10 is controlled by a computer 12. Computer 12 has, for example, the following components: a memory 14 storing one or more applications 16; a secondary storage 18 providing for non-volatile storage of information; an input device 20 for receiving information or commands; a processor 22 for executing applications stored in memory 16 or secondary storage 18, or received from another source; a display device 24 for outputting a visual display of information; and an output device 26 for outputting information in other forms such as speakers for audio information or a printer for a hardcopy of information.

The cutting of a work piece 54 is performed by a tool tip 44. An actuator 38 controls movement of tool tip 44 as work piece 54 is rotated by a drive unit and encoder 56, such as an electric motor controlled by computer 12. Examples of actuators for an FTS system are described in the following patents, all of which are incorporated herein by reference as if fully set forth: U.S. Pat. Nos. 7,290,471; 7,293,487; 7,350,441; and 7,350,442.

In the example shown in FIG. 1, work piece 54 is shown in roll form such as a hard copper roll; however, it can be implemented in planar form and make use of other materials for machining. For example, the work piece can be alternatively implemented with aluminum, nickel, steel, or plastics (e.g., acrylics). The particular material to be used may depend, for example, upon a particular desired application such as various films made using the machined work piece. Actuator 38 can be implemented with stainless steel, for example, or other materials.

Actuator 38 is removably connected to a tool post 36, which is in turn located on a track 32. The tool post 36 and actuator 38 are configured on track 32 to move in both an x-direction and a z-direction as shown by arrows 40 and 42. Computer 12 is in electrical connection with tool post 36 and actuator 38 via one or more amplifiers 30. When functioning as a controller, computer 12 controls movement of tool post 36 along track 32 and movement of tool tip 44 via actuator 38 for machining work piece 54. If an actuator has multiple PZT stacks, it can use separate amplifiers to independently control each PZT stack for use in independently controlling movement of a tool tip attached to the stacks. Computer 12 can make use of a function generator 28 in order to provide waveforms to actuator 38 in order to machine various microstructures in work piece 54.

The machining of work piece 54 is accomplished by coordinated movements of various components. In particular, the system, under control of computer 12, can coordinate and control movement of actuator 38, via movement of tool post 36, along with movement of the work piece in the C-direction and movement of tool tip 44 in one or more of the X-direction, Y-direction, and Z-direction, those coordinates being explained below. The system typically moves tool post 36 at a constant speed in the Z-direction, although a varying speed may be used. The movements of tool post 36 and tool tip 44 are typically synchronized with the movement of work piece 54 in the c-direction (rotational movement as represented by line 53). All of these movements can be controlled using, for example, numerical control techniques or a numerical controller (NC) implemented in software, firmware, or a combination in computer 12.

Work piece 54, after having been machined, can be used to make films having the corresponding microstructures for use in a variety of applications. Examples of those films include optical films, friction control films, and micro-fasteners or other mechanical microstructured components. The films are typically made using a coating process in which a material in a viscous state is applied to the work piece, allowed to at least partially cure, and then removed. The film composed of the cured material will have substantially the opposite structures than those in the work piece. For example, an indentation in the work piece results in a protrusion in the resulting film. Alternatively, the work piece can be used to make films in a co-extrusion process, an example of which is described in U.S. Provisional Patent Application of G. Clarke et al., entitled “Optical Films with Internally Conformable Layers and Method of Making the Films,” and filed on even date herewith, which is incorporated herein by reference as if fully set forth.

Cooling fluid 46 is used to control the temperature of tool post 36 and actuator 38 via lines 48 and 50. A temperature control unit 52 can maintain a substantially constant temperature of the cooling fluid as it is circulated through tool post 36 and actuator 38. Temperature control unit 52 can be implemented with any device for providing temperature control of a fluid. The cooling fluid can be implemented with an oil product, for example a low viscosity oil. The temperature control unit 52 and reservoir for cooling fluid 46 can include pumps to circulate the fluid through tool post 36 and actuator 38, and they also typically include a refrigeration system to remove heat from the fluid in order to maintain it at a substantially constant temperature. Refrigeration and pump systems to circulate and provide temperature control of a fluid are known in the art. The cooling fluid can also be applied to work piece 54 in order to maintain a substantially constant surface temperature of the material to be machined in the work piece.

### Flycutting System

Flycutting typically refers to the use of a cutting element, such as a diamond, that is mounted on or incorporated into a shank or tool holder that is positioned at the periphery of a rotatable head or hub, which is then positioned relative to the surface of the workpiece into which grooves or other features are to be machined. Flycutting is typically a discontinuous cutting operation, meaning that each cutting element is in contact with the workpiece for a period of time, and then is not in contact with the workpiece for a period of time during which the flycutting head is rotating that cutting element through the remaining portion of a circle until it again contacts the workpiece. Although a flycutting operation is typically discontinuous, the resulting groove segment or other surface feature formed in a workpiece by the flycutter may be continuous (formed by a succession of individual, but connected cuts, for example) or discontinuous (formed by disconnected cuts), as desired. Although flycutting typically involves removing material from a workpiece by using a cutting element, it can also include peening or otherwise deforming a surface using a modified flycutting head equipped with peening elements rather than cutting elements. Examples of a flycutting systems are described in U.S. patent applications Ser. Nos. 11/834393 and 11/834371, both of which were filed on Aug. 6, 2007 and are incorporated herein by reference as if fully set forth.

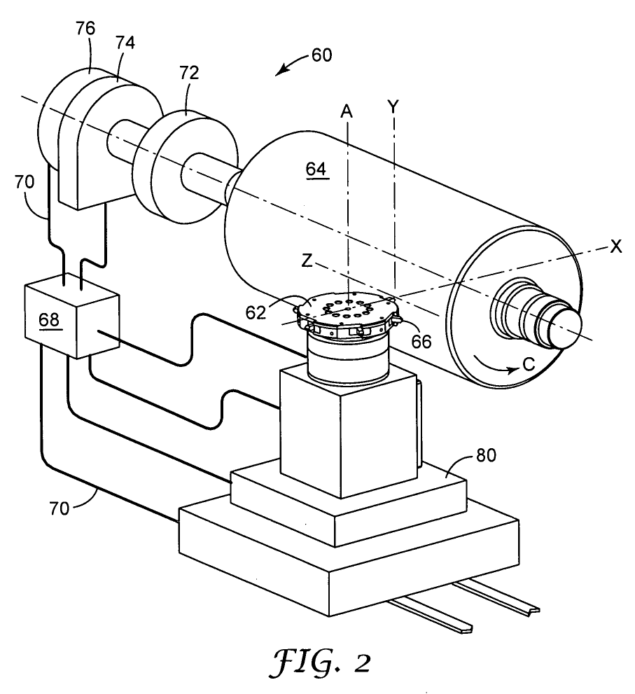

FIG. 2 illustrates an example of a flycutting system 60, including a flycutting head 62 positioned relative to a workpiece. The workpiece may be a roll 64 made of metal, such as stainless steel, with an outer layer made of a material that is more easily tooled, such as brass, aluminum, nickel phosphorus, hard copper, or polymer. For simplicity, the workpiece will often be referred to in this description as a “roll,” but the workpiece could with suitable adaptations to the system be planar, convex, concave, or of a complex or other shape. Accordingly the term “roll” in this description is intended to exemplify workpieces of any suitable shape. The workpiece may include a test band at one end, on which the flycutting head can be programmed to cut a test pattern to determine whether the head and the workpiece are positioned and synchronized appropriately relative to each other. The characteristics of the features formed in the test band can then be evaluated, and once the operation of the flycutting head and the workpiece have been optimized, the actual machining operation can be performed on a different portion of the workpiece. Test bands are not required, but they may be useful for determining what adjustments may have to be made to cause the actual performance of the system to match the desired or theoretical performance of the system.

The flycutting head, in this example, carries at least one tool holder, which holds or includes a cutting element 66. The cutting element may be a suitable industrial diamond selected to cut one or more grooves or other features in the outer surface of the roll, or another suitable cutting element such as a sharp metal point. Although the formations created in the workpiece by a cutting element may be referred to for simplicity herein as “grooves” or “groove segments,” they may depending on their characteristics also be referred to as valleys, slots, indentations, scallops or, generically, “features.”

A coordinate system may be designated, as shown in FIG. 2, with regard to the flycutting head 62 and workpiece 64. These coordinate system designations are arbitrary and provided to facilitate an understanding of the a flycutting system. The coordinate system is shown relative to the tip of the cutting element, and includes mutually orthogonal X, Y, and Z axes. The X axis is perpendicular to roll 64 passes through the central axis of rotation of roll 64. The Y axis extends vertically, as shown in FIG. 2, and is parallel to or coincident with a tangent to the outer surface of the roll. The Z axis extends horizontally and parallel to the central axis of the roll. The workpiece also has a rotational axis C, and the workpiece may be rotated in either direction with respect to that axis. The flycutting head 62 has an axis of rotation A, which is parallel to the Y axis in FIG. 2. If the workpiece is planar (such as a plate or disc) rather than cylindrical, then corresponding adaptations in the preceding designations of the various axes can be made.

As shown in FIG. 2, system 60 is controlled by a computer or controller 68, which may include or be operatively connected to memory for storing one or more applications, secondary storage for non-volatile storage of information, a function generator for generating waveform data files that can be output to an actuator or other device, an input device for receiving information or commands, a processor for executing applications stored in memory or secondary storage or received from another source, a display device for outputting a visual display of information, or an output device for outputting information in other forms such as speakers or a printer, or any combination of two or more of the foregoing. The controller may exchange data or signals using cables 70, or a suitable wireless connection.

The workpiece—roll 64 in the illustrated embodiments—may be fixedly supported on a spindle system that is driven by a motor that is controlled by and receives command signals from the controller. The bearings can be positioned and supported in any suitable location with respect to a workpiece. The roll may be rotated in either direction by a motor 74 or, if the workpiece is not cylindrical or is positioned using a different system, positioned in response to instructions provided by the controller 68. An exemplary motorized spindle system is available from Professional Instruments of Hopkins, Minn., under the designation 4R, or under the designation 10R (which includes an air bearing), or, for larger workpieces, a oil hydrostatic spindle system from Whitnon Spindle Division, Whitnon Manufacturing Company, of Farmington, Conn. The spindle system preferably also includes a rotary encoder 26 that is adapted to detect the position of the spindle and thus the workpiece to within a desired degree of accuracy, and to transmit that information to the controller to enable the controller to synchronize the workpiece and the flycutting head in the manner described below.

The flycutting head is preferably supported on a flycutting table 80, which may be referred to as an “x-table.” The x-table is adapted for movement along at least one of the X, Y, and Z axes, preferably along both the X and Z axes as shown in FIG. 2, and more preferably along all three of the X, Y, and Z axes sequentially or preferably simultaneously, to position the flycutting head and the cutting element(s) relative to the workpiece. As is known in the art, the x-table can move in more than one dimension or direction essentially simultaneously, so that the location of the cutting tip can be easily positioned in three-dimensional space under the control of the controller.

An actuator receives signals from the controller 68, and thereby controls the manner in which cutting element 66 creates features such as cuts or grooves in the workpiece. The actuator is preferably removably connected to the flycutting head 62 either directly, or indirectly via a cartridge or carrier.

Other conventional machining techniques may useful in connection with the inventive system and its components. For example, cooling fluid may be used to control the temperature of the cutting elements, the flycutting head, the actuators, or other components. A temperature control unit may be provided to maintain a substantially constant temperature of the cooling fluid as it is circulated. The temperature control unit and a reservoir for cooling fluid can include pumps to circulate the fluid through or to the various components, and they also typically include a refrigeration system to remove heat from the fluid in order to maintain the fluid at a substantially constant temperature. Refrigeration and pump systems to circulate and provide temperature control of a fluid are known in the art. The cooling fluid can also be applied to the workpiece to maintain a substantially constant surface temperature while the workpiece is being machined. The cooling fluid can be an oil product, such as a low-viscosity oil.

Other aspects of the machining process are also known to persons of skill in the art. For example, a roll may be dry-cut, or cut using oil or another processing aid; high-speed actuators may require cooling; clean, dry air should be used with any air bearings, such as those that support the spindle; and the spindle may be cooled using an oil cooling jacket or the like. Machining systems of this type are typically adapted to account for a variety of parameters, such as the coordinated speeds of the components and the characteristics of the workpiece material, such as the specific energy for a given volume of metal to be machined, and the thermal stability and properties of the workpiece material.

The machining of a workpiece is preferably accomplished by coordinated movements of various components of the system. In order to provide grooves or other features at predetermined locations on a workpiece, the position of each cutting element that is carried by the flycutting head should be coordinated or synchronized with the position of the workpiece. For example, where an aligned set of groove segments parallel to the Z axis is to be cut into a roll that will rotate while being machined, the control system preferably positions the cutting element of the flycutting head appropriately relative to the roll so that successive groove segments are in fact aligned.

This synchronization may be done by providing a position encoder (such as an angular encoder) associated with the roll and another position encoder associated with the flycutting head. At least two types of encoders are currently available—incremental and absolute. Incremental encoders may be less expensive, and if used with an index signal that is indicative of a known position of the roll or the flycutting head, for example, may function effectively as an absolute encoder. The encoder 76 associated with the roll (or the spindle on which the roll is mounted) should have a resolution sufficient to detect the position of the roll along its axis of rotation to within a fraction of the desired groove pitch or other dimension of the features being machined into the roll. The groove pitch is the distance from the center of one groove to the center of the next adjacent groove, or the distance from one peak to the next adjacent peak, and a corresponding dimension can normally be calculated for other surface features. The rotational position of the spindle, the rotational position of the flycutter head, and the z axis position of the flycutter platform can all be coordinated and controlled relative to each other. Other synchronization methods may also be used, as appropriate, for example to cut grooves or other features into a roll at an angle relative to the central axis of the roll. The positions and velocities of the various components can be controlled using, for example, numerical control techniques or a numerical controller (NC) implemented in software, firmware, or a combination in the controller.

In cases in which the workpiece is a cylindrical roll that is rotating around its longitudinal axis, a flycutting head that is arranged to cut a groove or succession of grooves parallel to that axis may need to be re-oriented so that the resulting groove or succession of grooves is actually parallel. In other words, if the cutting element would cut a parallel groove in the roll when the roll is stationary, then it would (if other parameters were held constant) cut a slightly curved groove in the roll if the roll is permitted to rotate during the cut. One way to offset this effect is to angle the cutting head so that the cutting element at the end of its cut is farther in the direction of rotation of the roll than at the beginning of its cut. Because the cutting element is in contact with the roll over only a short distance, the result can be to approximate a parallel groove segment in the roll surface notwithstanding the rotation of the roll. It may be possible to adapt the system in other ways to accomplish the same or a similar objective, for example by enabling the flycutting head to rotate around the central axis of the roll so that it follows the roll as it rotates, although this may be expensive to implement.

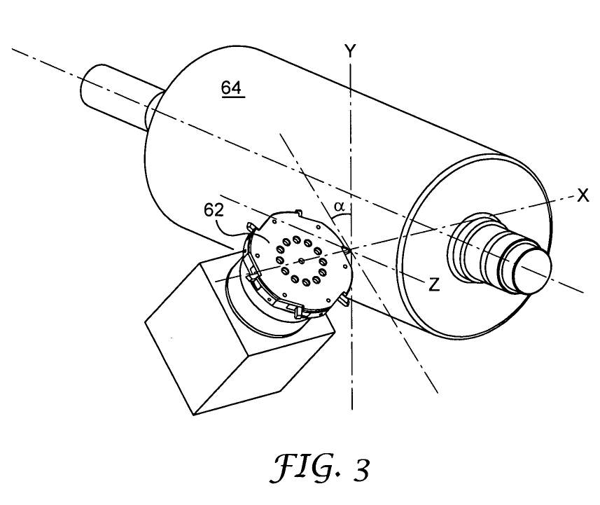

FIG. 3 illustrates the flycutting system in which the flycutting head is arranged at an angle α relative to the Y axis, enabling it to form features in the workpiece at approximately a 45 degree angle relative to the longitudinal axis of the workpiece. The coordinate system in which the angle α is measured is arbitrary, and is not intended to limit the other positions or orientations at which the head can be positioned. The angle α can range from 0 to 360 degrees. In general, the flycutting head may be angled with respect to, or rotated around (or tilted with respect to), any axis.

### Variable Prismatic Films

An exemplary method of making variable prismatic structures includes using systems 10 and 60 to machine a workpiece using both diamond turning machining with an FTS actuator and flycutting. In particular, such method involves generating the first pass along the X axis using an FTS function and tool to generate the desired structure. The FTS cutting creates continuous features, such as grooves, in the workpiece. The second pass on the workpiece passes through the first structure along the Y axis, or at an angle to it, using flycutting. The flycutting creates discontinuous features, such as groove segments, in the workpiece. The discontinuous features are preferably created at an angle between 45 degrees and 90 degrees to the continuous features, and more preferably at angle of approximately 80 degrees to the continuous features. The FTS actuator preferably uses an ion milled curved or segmented diamond tool tip for the cutting of the continuous features, and the flycutting preferably uses a prismatic tool tip for the cutting of the discontinuous features. Also, the continuous features and discontinuous features each preferably have a pitch equal to or less than 300 microns, more preferably equal to or less than 114 microns, 62 microns, or 30 microns.

As an alternative, the method can involve first machining the workpiece using flycutting and then machining the workpiece using an FTS actuator. The method can optionally include dithering the C axis to introduce chaos in the C axis during the flycutting and FTS machining, or during only one of them. The term “chaos” refers to an aspect of controlling a machining of a workpiece that is at least partially random or without order. It also possible to use chaos along the X, Y, or Z axes while cutting features in the workpiece or to use chaos along any combination of those axes.

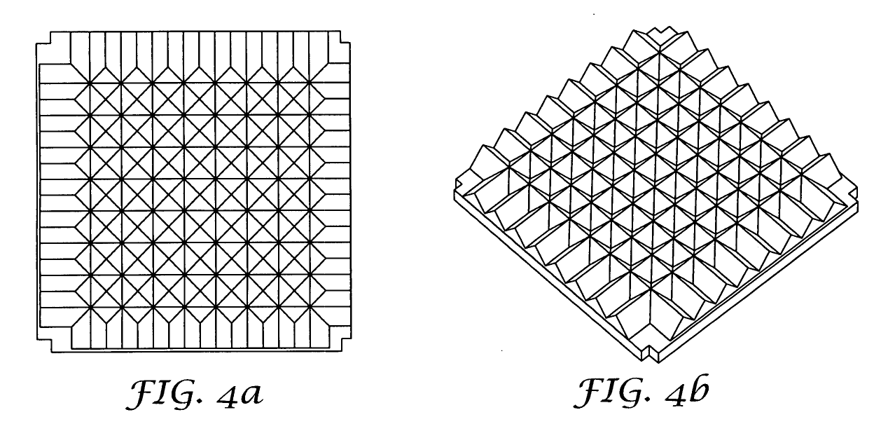

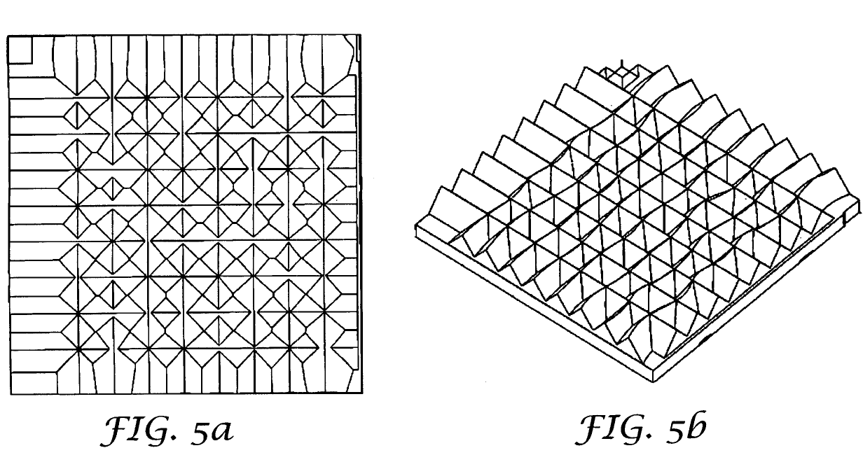

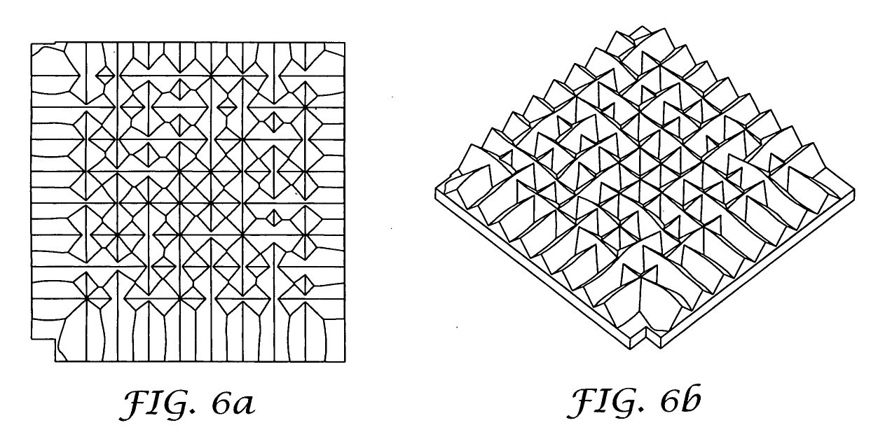

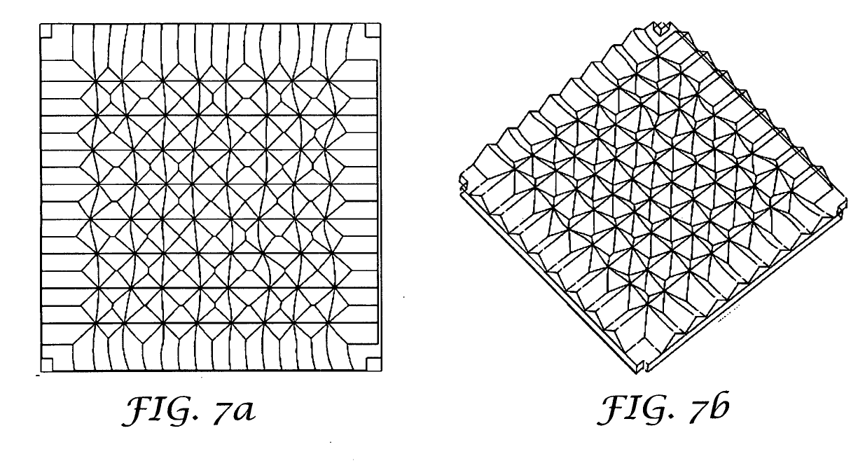

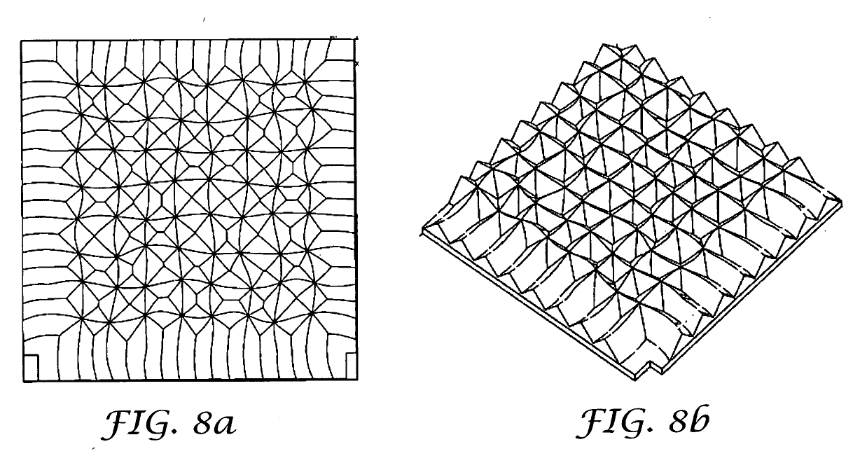

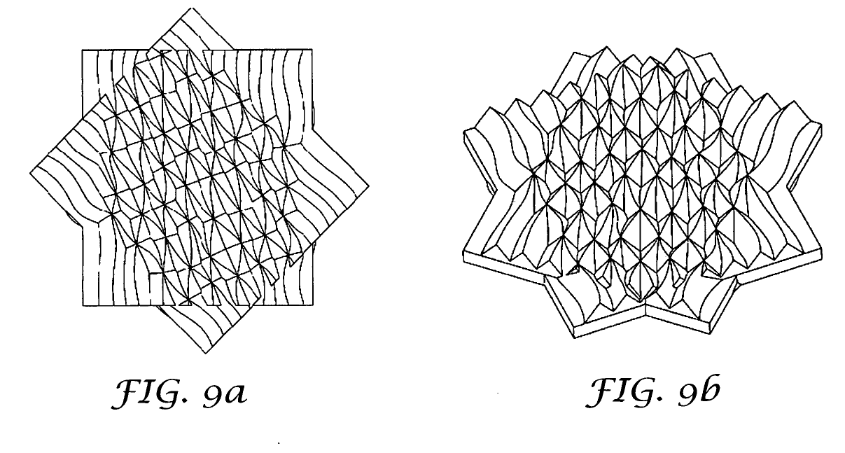

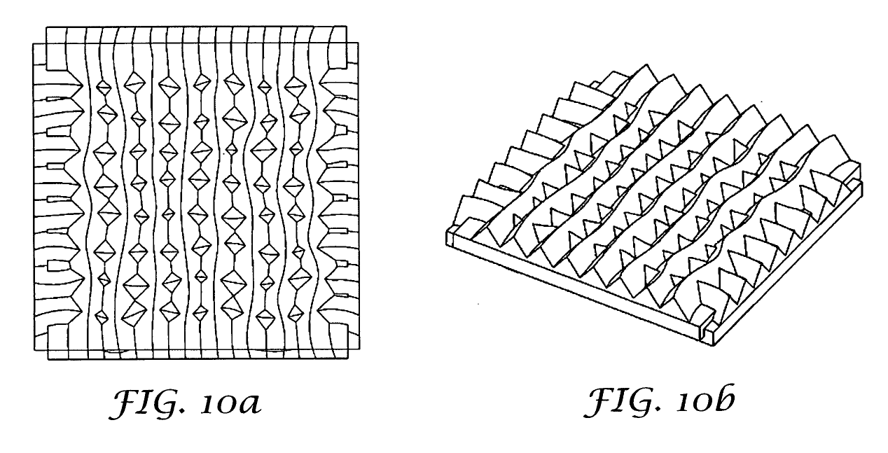

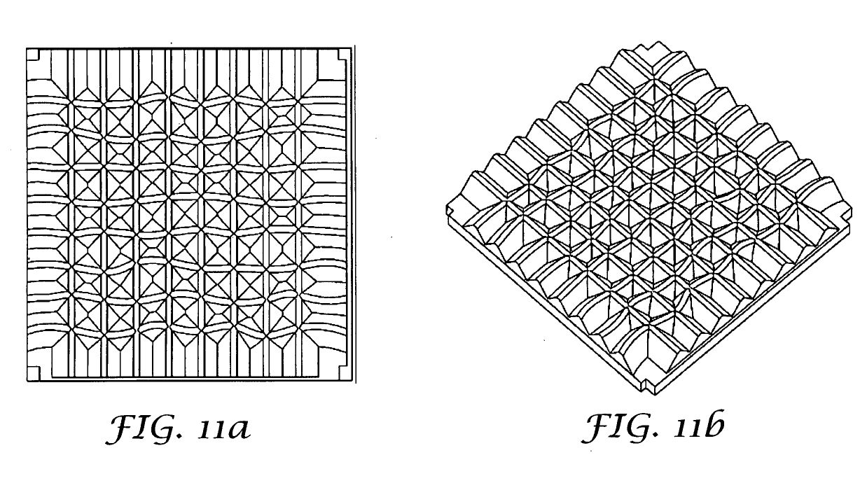

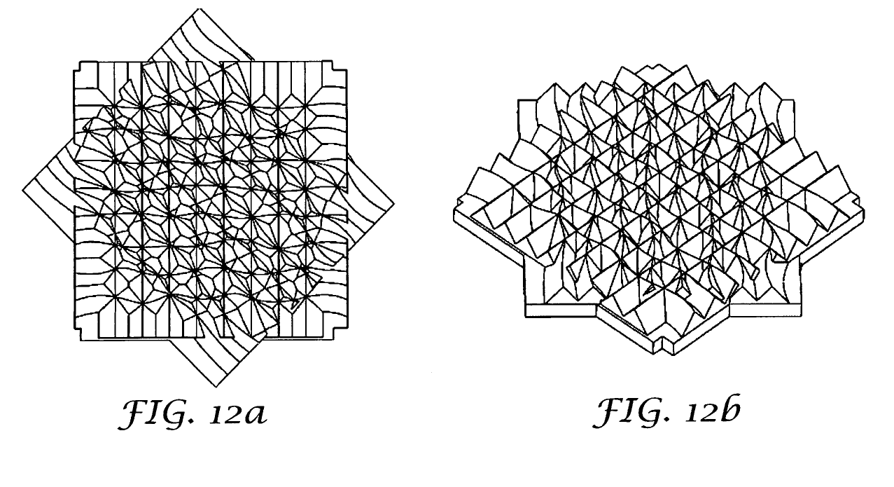

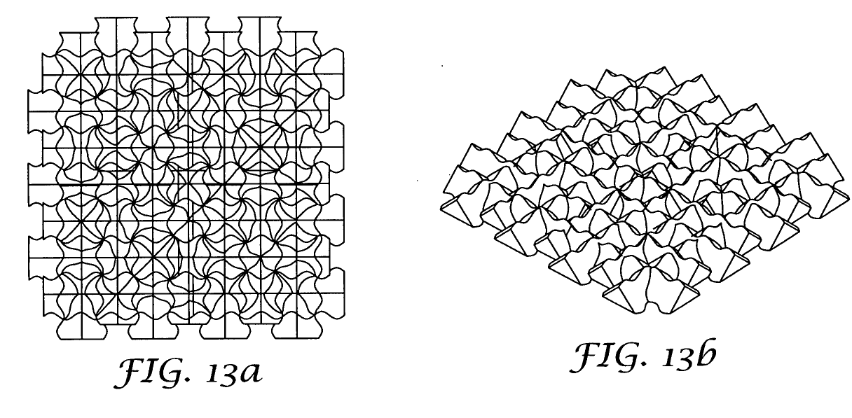

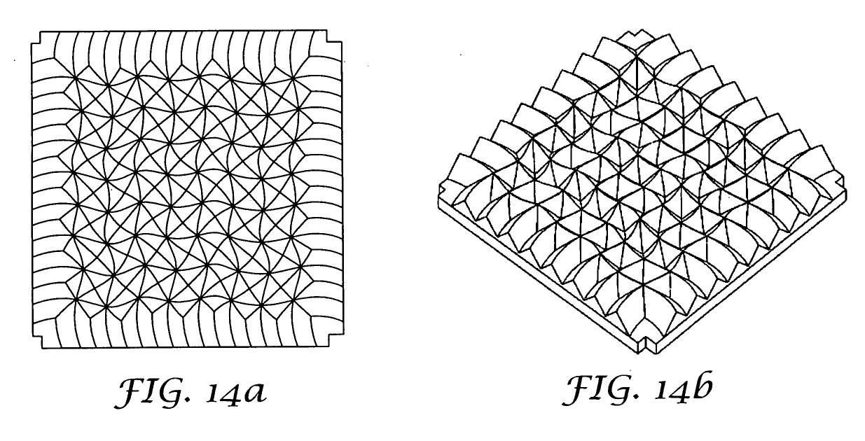

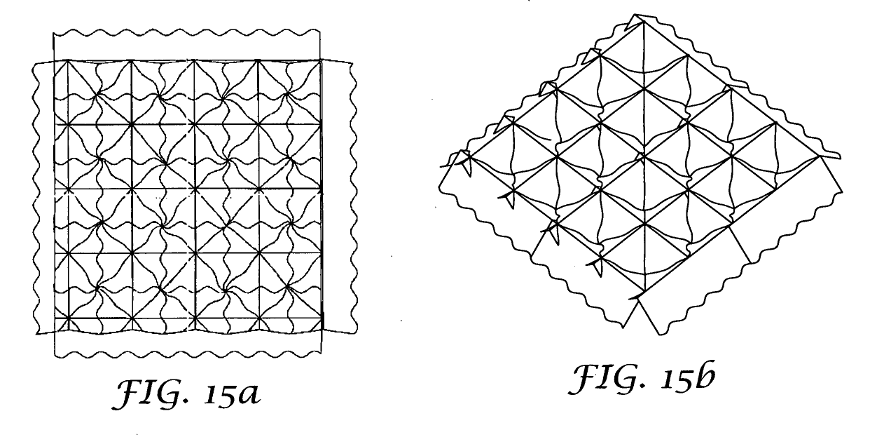

After being machined, the workpiece can be used to make films having the corresponding structures as those machined in the surface of the workpiece. FIGS. 4-15 illustrate top and perspective views of articles having various prismatic structured surfaces, as identified above, in films made from machined workpieces having prismatic structures.

1. A method for machining a workpiece, comprising:
machining a surface of the workpiece using an FTS actuator to make continuous features in the surface; and
machining the surface of the workpiece using flycutting to make discontinuous features in the surface through the continuous features,
wherein the discontinuous feature are machined at a non-parallel angle to the continuous features.

2. The method of claim 1, wherein the workpiece has a substantially cylindrical shape.

3. The method of claim 1, wherein the surface of the workpiece comprises a copper material.

4. The method of claim 1, wherein the machining using the FTS actuator is performed before the machining using the flycutting.

5. The method of claim 1, wherein the machining using the flycutting uses C axis chaos during the flycutting machining.

6. The method of claim 1, wherein the machining using the FTS actuator uses C axis chaos during the FTS machining.

7. The method of claim 1, wherein the discontinuous features intersect the continuous features at an angle between 45 degrees and 90 degrees.

8. The method of claim 1, wherein the discontinuous features intersect the continuous features at an angle of approximately 80 degrees.

9. The method of claim 1, wherein the discontinuous features have a depth different from a depth of the continuous features.

10. The method of claim 1, wherein the machining using flycutting comprises uses Y axis chaos during the flycutting machining.

11. The method of claim 1, wherein the machining using the FTS actuator comprises using X axis chaos during the FTS machining.

12. The method of claim 1, wherein the machining using flycutting comprises uses Z axis chaos during the flycutting machining.

13. The method of claim 1, wherein the machining using the FTS actuator comprises using Z axis chaos during the FTS machining.

14. The method of claim 1, wherein the discontinuous features have a pitch equal to or less than 300 microns.

15. The method of claim 1, wherein the continuous features have a pitch equal to or less than 300 microns.

16. The method of claim 1, further comprising making a film from the machined workpiece.
